(19) United States
(12) Patent Application Publication
(10) Pub. No.: US 2024/0241530 A1
(43) Pub. Date: Jul. 18, 2024

(54) DYNAMIC MODELS FOR MOTOR WINDING TEMPERATURE

(71) Applicant: FORD GLOBAL TECHNOLOGIES, LLC, Dearborn, MI (US)

(72) Inventors: Monty Anderson, Boise, ID (US); William Robert Brown, Huntington Woods, MI (US); Papiya Bagchi, Northville, MI (US); Justin Barsano, Hazel Park, MI (US)

(21) Appl. No.: 18/098,263

(22) Filed: Jan. 18, 2023

(51) Int. Cl. G05D 23/19; G05B 19/042

(52) U.S. Cl. CPC G05D 23/1917; G05B 19/042; B60K 6/26

(57) ABSTRACT

An electric drive system includes a permanent magnet synchronous motor. The stator of the motor has windings which are subject to temperature limits. Dynamic models are used to estimate the temperatures of the windings both in a center section and at the ends of the windings. Inputs to these dynamics models include rotor speed, winding current, oil flow rate, sump temperature, and ambient temperature. Empirical constants in the models are set based on vehicle testing.

### TECHNICAL FIELD

The present invention relates to control of electric motors in electrified vehicle powertrains. More particularly, the disclosure relates to use of dynamic models to estimate winding temperature and control the motor accordingly.

### BACKGROUND

An electric drive system includes a battery, a power electronics module, and a motor. During operation, the stator windings of the motor may increase in temperature due to copper losses and iron losses. The windings are cooled by various mechanisms. To avoid exceeding design temperature limits, the motor operating envelop must occasionally be restricted based on winding temperatures. However, sensors to directly measure the winding temperatures are expensive and unreliable.

### SUMMARY

An electric drive system includes a motor and a controller. The motor has a rotor and a stator. The stator has a plurality of windings. The controller is programmed to control a winding current such that the motor produces torque and power. The controller is also programmed to reduce a motor operating limit, such as a maximum rotor speed, in response to an estimate of a temperature of the windings, such as a temperature of a center section of the windings, exceeding a threshold. The estimate is output by a dynamic model, which may be a second order dynamic model, having rotor speed as an input. The inputs of the dynamic model may also include an oil flow rate through the motor, the winding current, an ambient temperature, and a sump temperature.

A method of operating a motor of an electric drive system includes adjusting a winding current and reducing an operating limit. The winding current is adjusted by a controller such that the motor produces torque. The operating limit of the motor, such as a maximum rotor speed, is reduced in response to an estimated center section winding temperature exceeding a first threshold. The center section winding temperature is estimated by the controller using a first dynamic model, which may be a second order dynamic model, based on a rotor speed. Inputs to the first dynamic model may also include an oil flow rate through the motor, the winding current, an ambient temperature, and a sump temperature. The controller may also estimate an end winding temperature using a second dynamic model based on the oil flow rate, the winding current, the ambient temperature, and the sump temperature. The operating limit of the motor may also be reduced in response to the estimated end winding temperature exceeding a second threshold. At least one instrumented test vehicle may be operated to record data including measured motor center section winding temperature and measured rotor speed and model constants may be computed based on the recorded data.

An electric drive system includes a motor, a pump, and a controller. The motor has a rotor and a stator. The stator has a plurality of windings. The pump is configured to circulate oil from a sump through the motor. The controller is programmed to control a winding current such that the motor produces torque and power. The controller is further programmed to reduce a motor operating limit, such as a maximum rotor speed, in response to an estimate of a temperature of the windings, such as a temperature of a center section of the windings, exceeding a threshold. The estimate is output by a dynamic model, such as a second order dynamic model, having a rate of flow of the oil as an input. The inputs of the dynamic model may also include a rotor speed, the winding current, an ambient temperature, and a sump temperature.

### BRIEF DESCRIPTION OF THE DRAWINGS

FIG. 1 illustrates a block diagram of an electric vehicle.

FIG. 2 is a block cross section of an exemplary permanent magnet synchronous motor.

FIG. 3 is a diagram illustrating the operating envelope of a motor, such as the motor of FIG. 2.

FIG. 4 is a flow chart for operating a motor of a vehicle powertrain.

FIG. 5 is a block diagram of a first order winding temperature model.

FIG. 6 is a block diagram of a second order winding temperature model.

FIG. 7 is a flow chart for producing vehicles that utilize dynamic models for winding temperature prediction.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

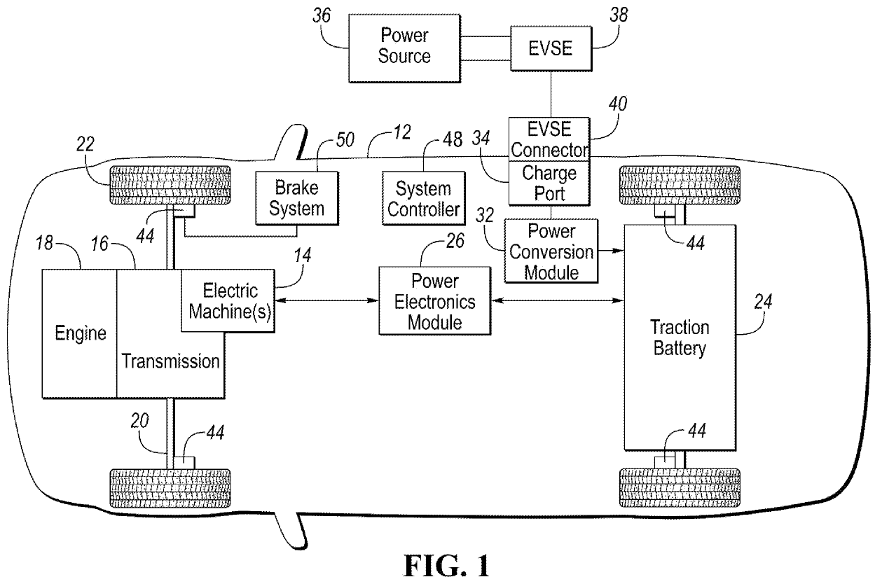

Referring now to FIG. 1, a block diagram of an exemplary electric vehicle (“EV”) 12 is shown. In this example, EV 12 is a plug-in hybrid electric vehicle (PHEV). EV 12 includes one or more electric machines 14 (“e-machines”) mechanically connected to a transmission 16. Electric machine 14 is capable of operating as a motor and as a generator. Transmission 16 is mechanically connected to an engine 18 and to a drive shaft 20 mechanically connected to wheels 22. Electric machine 14 can provide propulsion and slowing capability while engine 18 is turned on or off. Electric machine 14 acting as a generator can recover energy that may normally be lost as heat in a friction braking system. Electric machine 14 may reduce vehicle emissions by allowing engine 18 to operate at more efficient speeds and allowing EV 12 to be operated in electric mode with engine 18 off under certain conditions.

A traction battery 24 (“battery) stores energy that can be used by electric machine 14 for propelling EV 12. Battery 24 typically provides a high-voltage (HV) direct current (DC) output. Battery 24 is electrically connected to a power electronics module 26. Power electronics module 26 is electrically connected to electric machine 14 and provides the ability to bi-directionally transfer energy between battery 24 and the electric machine. For example, battery 24 may provide a DC voltage while electric machine 14 may require a three-phase alternating current (AC) voltage to function. Power electronics module 26 may convert the DC voltage to a three-phase AC voltage to operate electric machine 14. In a regenerative mode, power electronics module 26 may convert three-phase AC voltage from electric machine 14 acting as a generator to DC voltage compatible with battery 24.

Battery 24 is rechargeable by an external power source 36 (e.g., the grid). Electric vehicle supply equipment (EVSE) 38 is connected to external power source 36. EVSE 38 provides circuitry and controls to control and manage the transfer of energy between external power source 36 and EV 12. External power source 36 may provide DC or AC electric power to EVSE 38. EVSE 38 may have a charge connector 40 for plugging into a charge port 34 of EV 12. Charge port 34 may be any type of port configured to transfer power from EVSE 38 to EV 12. A power conversion module 32 of EV 12 may condition power supplied from EVSE 38 to provide the proper voltage and current levels to battery 24. Power conversion module 32 may interface with EVSE 38 to coordinate the delivery of power to battery 24. Alternatively, various components described as being electrically connected may transfer power using a wireless inductive coupling.

Wheel brakes 44 are provided for slowing and preventing motion of EV 12. Wheel brakes 44 are part of a brake system 50. Brake system 50 may include a controller to monitor and control wheel brakes 44 to achieve desired operation.

The various components discussed may have one or more associated controllers to control and monitor the operation of the components. The controllers can be microprocessor-based devices. The controllers may communicate via a serial bus (e.g., Controller Area Network (CAN)) or via discrete conductors. For example, a system controller 48 (i.e., a vehicle controller) is present to coordinate the operation of the various components.

As described, EV 12 is in this example is a PHEV having engine 18 and battery 24. In other embodiments, EV 12 is a battery electric vehicle (BEV). In a BEV configuration, EV 12 does not include an engine.

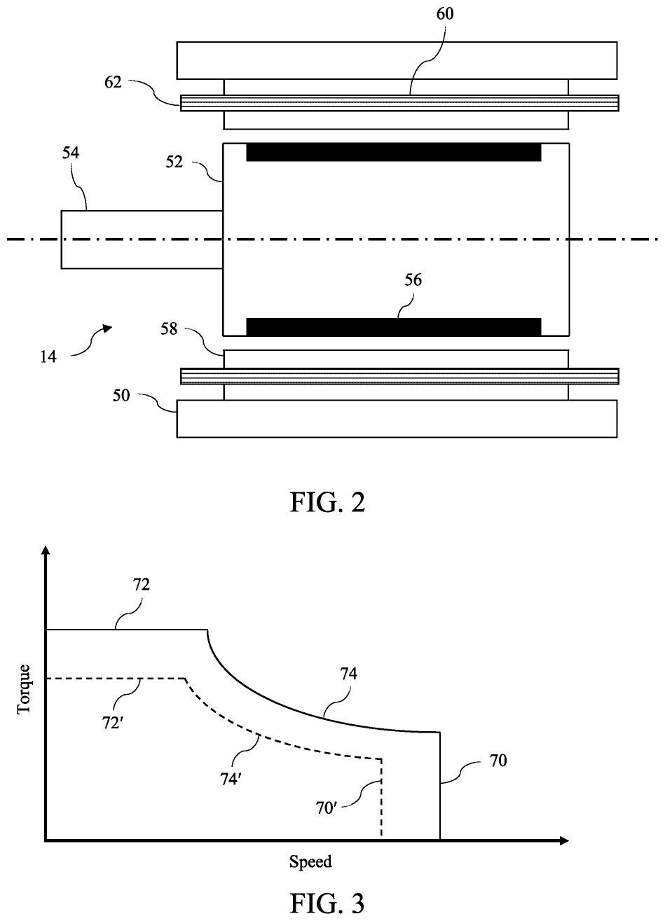

Referring now to FIG. 2, a cross section of a permanent magnet synchronous motor, such as electric machine 14, is shown. Motor 14 includes a fixed stator 50 and a rotor 52 supported for rotation therein. Rotor 52 is fixed to a rotor shaft 54 which transmits power from the motor to other parts of the powertrain or directly to vehicle wheels. A number of magnets 56 are embedded in a periphery of rotor 52. Stator 50 includes a number of poles which protrude inwardly from a cylindrical body. Wire is wound around each of the poles and connected to an AC electrical source. AC current in the wire establishes a changing magnetic field in the poles. The wire around each pole is called a winding. Each winding includes a center section 60 adjacent to the rotor and end-windings 62 at the ends.

While a majority of the electrical power applied to the windings is converted to mechanical power at shaft 54, some of the power is converter to heat, causing motor components to increase in temperature. One form of power loss, called copper loss, is due electrical resistance and current in the windings. Copper loss is proportional to the electrical resistance, R, and to the square of the current, I². Another form of power loss, called iron loss, is due to the magnetic resistance and the magnetic field strength. Iron loss is proportional to the magnetic resistance and to the square of the speed of the motor, ω². The end-windings are heated primarily by copper loss. Heat from the end-windings is dissipated primarily by oil splashing against the end-windings. The center section is heated by both copper losses and by iron losses. Heat is dissipated by conduction through the poles and cylinder of the stator to either the exterior surface or to a portion of the stator that is cooled by the oil. The oil may be circulated by a pump from a sump, through the motor, through a radiator that provides opportunity for heat transfer from the oil to ambient air, and back to the sump.

The motor has an operating envelope in terms of speed, torque, and power. One quadrant of this envelope, corresponding to positive speed and toque, is illustrated in FIG. 3. The speed, torque, and power are limited to prevent excessive winding temperatures, among other factors. The normal operating envelope may be bounded by a maximum speed 70, a maximum torque 72, and a maximum power 74. Similar limits exist for negative speeds and negative torques which may or may not have the same values. In response to a winding temperature approaching an upper limit, the operating envelope may be temporarily restricted to prevent further increases in winding temperatures. This restriction may take the form of a reduced maximum speed 70′, a reduced maximum torque 72′, a reduced maximum power 74′ or various combinations of the these.

Due to the harsh environment within the motor, directly measuring the winding temperature may be unreliable. Physical space available for attaching thermocouples is limited, especially at the center section of the windings. Thermocouples may come loose during usage and produce inaccurate measurements or no measurements at all. For these reasons, it is desirable to estimate the temperatures in both the end-windings and the center sections using mathematical models based on quantities that are more easily measured. No model perfectly estimates a physical quantity in all operating circumstances. Therefore, thresholds at which corrective actions are initiated must be set conservatively to ensure that action is taken even when the estimate is less than the actual temperature. Thresholds may be set higher if the model is more accurate, reducing the frequency and degree of operating envelope reductions.

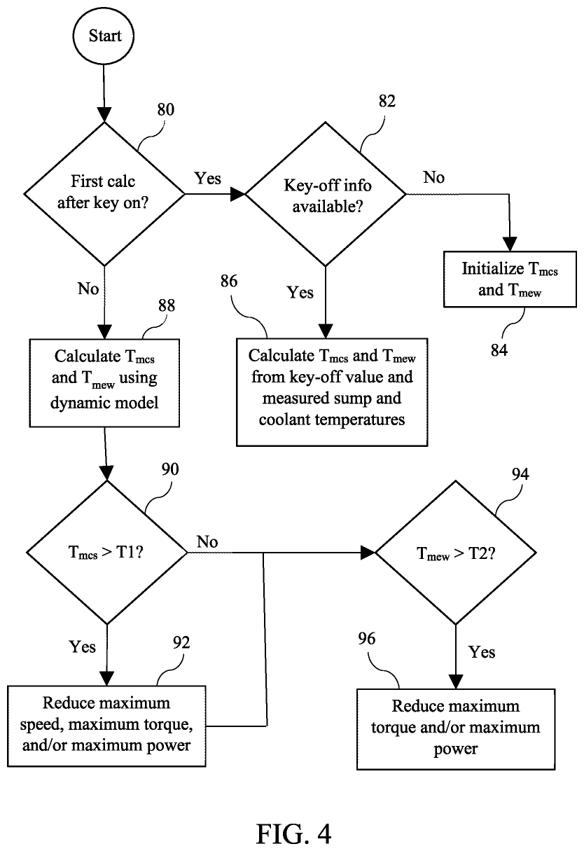

FIG. 4 illustrates a control algorithm for operating a motor in a vehicle powertrain. This algorithm is executed by a controller, such as 48 or 26, at regular intervals whenever the key is on. For example, the algorithm may be executed every 100 ms in response to an interrupt signal. At 80, the controller checks whether this is the first calculation since turning the key on. If so, then the controller checks at 82 whether information was saved from the most recent key-off event. If not, then the controller initializes T_{mcs}, the estimated motor central section temperature, and T_{mew}, the estimated motor end-winding temperature, to default values at 84. If key-off information is available at 82, then the controller calculates T_{mcs} and T_{mew} from these values and measured sump and coolant temperatures at 86. Specifically, based on how much time has passed since the key-off event, the controller estimates how much the motor would have cooled down in the measured conditions. If this is not the first calculation since key-on, then the controller uses a dynamic model to calculate T_{mcs} and T_{mew} at 88. The dynamic model is discussed in more detail below. At 90, the controller checks whether the calculated T_{mcs} exceeds a threshold for center section, T1. If so, the controller reduces at least one of a maximum speed, a maximum torque, or a maximum power at 92. The degree of reduction from nominal values may depend on the current value of T_{mcs} and on a rate of change of T_{mcs}. Similarly, if T_{mew} exceeds a threshold for end-windings at 94, the controller reduces at least one of the maximum torque or the maximum power at 96.

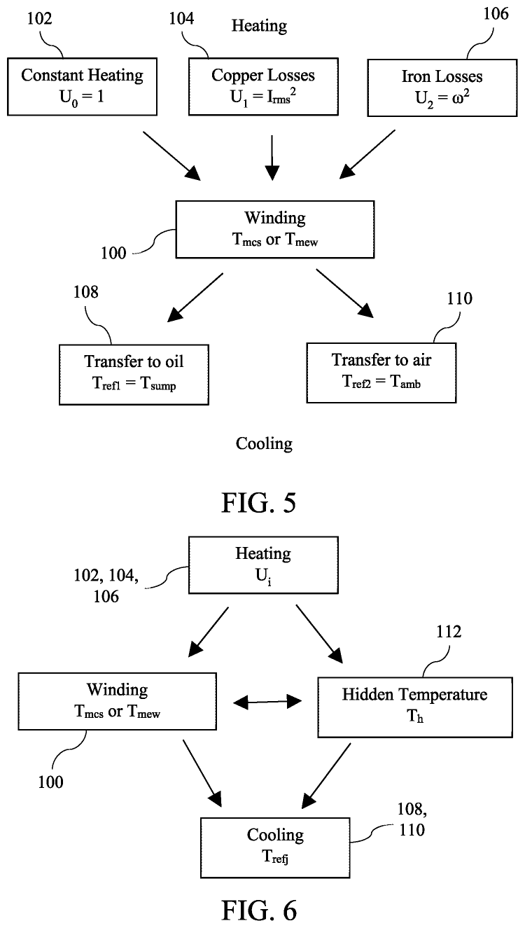

FIG. 5 is a 1^{st} order block diagram of the effects considered by the dynamic thermal models. The models for center section temperature and for end-winding temperature are separate models, but have the same structure so FIG. 5 applies to both of them. Block 100 represents the heat stored in the winding as characterized by the quantity T_{mcs} or T_{mew}. Three sources of heating, constant heating 102, copper losses 104, and iron losses 106 are considered. Two sources of cooling, transfer to oil 108, and transfer to ambient air 110 are considered. Transfer to oil is a function of the temperature of the oil measured at the sump Tₛᵤₘₚ while transfer to ambient air is a function of the ambient temperature measurement T_{amb}. For the remainder of this description, only the center section temperature model will be described in detail. The end-winding temperature model has identical structure but the coefficients will have different values.

Each heat flow rate is treated as a linear function of the oil flow rate F which is delivered by an oil pump. The temperature increase due to each heating source is Δt(Bₐᵢ+B_{bi}F)Uᵢ where Δt is the time between executions and Bₐᵢ and B_{bi} are empirical constants. The temperature decrease due to each cooling source is Δt(B_{ci}+B_{ci}F)(T_{mcs}−T_{refi}) where B_{ci} and B_{di} are empirical constants. In some powertrain configurations, the oil flow rate may be proportional to a speed of an internal combustion engine. A first-order dynamic model has the form:

$${T}_{m c s}^{+} = {T}_{m c s} + Δ t ( {B}_{1} + {B}_{2} F + ( {B}_{3} + {B}_{4} F ) {I}_{r m s}^{2} + ( {B}_{5} + {B}_{6} F ) {ω}^{2} + ( {B}_{7} + {B}_{8} F ) ( {T}_{s u m p} - {T}_{m c s} ) + ( {B}_{9} + {B}_{10} F ) ( {T}_{a m b} - {T}_{m c s} ) )$$

where T_{mcs}⁺ is the next motor center section temperature estimate.

FIG. 6 is a 2^{nd} order block diagram for the thermal models. For clarity, the various heating sources and cooling sources of FIG. 5 have been combined into single blocks. An additional heat sink 112 with temperature Tₕ is introduced to the 1^{st} order model of FIG. 5. Heat sink 112 is subject to the same heating and cooling loads as the winding 100. Additionally, heat flows between the winding 100 and heat source 112 in proportion to the temperature difference (T_{mcs}−Tₕ). The second order dynamic model has the form:

$${T}_{m c s}^{+} = {T}_{m c s} + Δ t ( ( {B}_{e} + {B}_{f} F ) ( {T}_{h} - {T}_{m c s} ) + \sum ( {B}_{a i} + {B}_{b i} F ) {U}_{i} + \sum ( {B}_{cj} + {B}_{dj} F ) ( {T}_{refj} - {T}_{m c s} ) )$$

$${T}_{h}^{+} = {T}_{h} + Δ t ( ( {B}_{e}^{h} + {B}_{f}^{h} F ) ( {T}_{m c s} - {T}_{h} ) + \sum ( {B}_{a i}^{h} + {B}_{bi}^{h} F ) {U}_{i} + \sum ( {B}_{c j}^{h} + {B}_{d j}^{h} F ) ( {T}_{refj} - {T}_{h} ) )$$

where the B and B^{h} terms with various subscripts are all empirical constants. An alternative form of 2^{nd} order model utilizes values from a previous time step, denoted with a “-” superscript, as opposed to an explicit additional heat sink.

$${T}_{m c s}^{+} = {T}_{m c s} + Δ t ( {B}_{1} + {B}_{2} F + ( {B}_{3} + {B}_{4} F ) {I}_{r m s}^{2} + ( {B}_{5} + {B}_{6} F ) {ω}^{2} + ( {B}_{7} + {B}_{8} F ) ( {T}_{s u m p} - {T}_{m c s} ) + ( {B}_{9} + {B}_{10} F ) ( {T}_{a m b} - {T}_{m c s} ) ) + Δ {t}^{2} ( ( {B}_{11} + {B}_{12} F ) {I}_{r m s}^{2 -} + ( {B}_{13} + {B}_{14} F ) {ω}^{2 -} + ( {B}_{15} + {B}_{16} F ) ( {T}_{sump}^{-} - {T}_{mcs}^{-} ) + ( {B}_{17} + {B}_{18} F ) ( {T}_{a m b}^{-} - {T}_{mcs}^{-} ) )$$

The inventors have discovered that a 2^{nd} order model of this form provides a more accurate prediction of the winding temperatures than the 1^{st} order model discussed above.

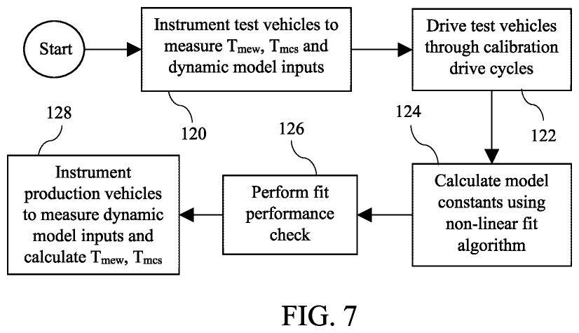

FIG. 7 is a block diagram illustrating the method of deploying winding temperature prediction models such as those discussed above. At 120, a set of test vehicles are instrumented to measure and record the model outputs T_{mew} and T_{mcs} as well as the model inputs F, I²ᵣₘₛ, ω², Tₛᵤₘₚ, and T_{amb} at regular intervals. For example, thermocouples may be installed on the stator windings. If it is not known in advance which position on the windings will be most critical, multiple thermocouples may be installed in different locations. Although the expense per vehicle of installing these thermocouples may be significant, the number of test vehicles is relatively small compared to the number of vehicles that will eventually be produced for sale to customers. At 122, the test vehicles are driven through a number of calibration drive cycles. These cycles are selected to subject the motors to a variety of conditions, including conditions that could result in winding temperatures approaching or exceeding design limits.

At 124, the data captured by the test vehicles during the drive cycles is processed using a non-linear fit algorithm to determine values for the empirical constants in the dynamic thermal models. At 126, a fit performance check is performed. For example, the models may be executed using the measured inputs during the drive cycles to determine what outputs the models would have predicted. Correlation between these predicted temperatures and the measured temperatures is analyzed to assess a maximum prediction error. Finally, at 128, production vehicles are instrumented to measure the model inputs but not the model outputs. In the production vehicles, the winding temperatures, both T_{mew} and T_{mcs}, are estimated by executing the dynamic model using the empirical constants. The maximum prediction error as determined at 126 may be used to set the temperature limit T1 and T2 from FIG. 4 at which the operating envelop is restricted.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. An electric drive system, comprising:
a motor having a rotor and a stator, the stator having a plurality of windings; and
a controller programmed to control a winding current such that the motor produces torque and power, the controller further programmed to reduce a motor operating limit in response to an estimate of a temperature of the windings exceeding a threshold, wherein the estimate is output by a dynamic model having rotor speed as an input.

2. The electric drive system of claim 1 wherein the inputs of the dynamic model further include an oil flow rate through the motor.

3. The electric drive system of claim 2 wherein the inputs of the dynamic model further include the winding current, an ambient temperature, and a sump temperature.

4. The electric drive system of claim 1 wherein the temperature of the windings is a temperature of a center section of the winding.

5. The electric drive system of claim 1 wherein the dynamic model is a second order dynamic model.

6. The electric drive system of claim 1 wherein the motor operating limit is a maximum rotor speed.

7. A method of operating a motor of an electric drive system, comprising:
adjusting, with a controller, a winding current such that the motor produces torque; and
reducing an operating limit of the motor in response to an estimated center section winding temperature exceeding a first threshold, wherein the center section winding temperature is estimated by the controller using a first dynamic model based on a rotor speed.

8. The method of claim 7 wherein the inputs of the first dynamic model further include an oil flow rate through the motor.

9. The method of claim 8 wherein the inputs of the first dynamic model further include the winding current, an ambient temperature, and a sump temperature.

10. The method of claim 9 further comprising:
estimating, with the controller, an end winding temperature using a second dynamic model based on the oil flow rate, the winding current, the ambient temperature, and the sump temperature; and
reducing the operating limit of the motor in response to the estimated end winding temperature exceeding a second threshold.

11. The method of claim 7 wherein the first dynamic model is a second order dynamic model.

12. The method of claim 7 wherein the motor operating limit is a maximum rotor speed.

13. The method of claim 12 further comprising:
operating at least one instrumented test vehicle to record data including measured motor center section winding temperature and measured rotor speed; and
computing model constants based on the recorded data.

14. An electric drive system, comprising:
a motor having a rotor and a stator, the stator having a plurality of windings;
a pump configured to circulate oil from a sump through the motor; and
a controller programmed to control a winding current such that the motor produces torque and power, the controller further programmed to reduce a motor operating limit in response to an estimate of a temperature of the windings exceeding a threshold, wherein the estimate is output by a dynamic model having a rate of flow of the oil as an input.

15. The electric drive system of claim 14 wherein the inputs of the dynamic model further include a rotor speed.

16. The electric drive system of claim 15 wherein the temperature of the windings is a temperature of a center section of the winding.

17. The electric drive system of claim 14 wherein the inputs of the dynamic model further include the winding current, an ambient temperature, and a sump temperature.

18. The electric drive system of claim 14 wherein the dynamic model is a second order dynamic model.

19. The electric drive system of claim 14 wherein the motor operating limit is a maximum rotor speed.
